(19) United States
(12) Patent Application Publication
(10) Pub. No.: US 2025/0376127 A1
(43) Pub. Date: Dec. 11, 2025

(54) AIRBAG CONTROL METHOD AND DEVICE

(71) Applicants: Robert Bosch GmbH, Stuttgart (DE); Bosch Automotive Products (Suzhou) Co. Ltd., Suzhou (CN)

(72) Inventor: Shaowei Zhong, Suzhou (CN)

(21) Appl. No.: 19/229,140

(22) Filed: Jun. 5, 2025

(30) Foreign Application Priority Data
Jun. 5, 2024 (CN) 2024 1072 2040.0

(51) Int. Cl. B60R 21/0132; B60R 21/01; B60W 60/00

(52) U.S. Cl. CPC B60R 21/0132; B60W 60/00; B60R 2021/01231

(57) ABSTRACT

A control method for an airbag includes (i) receiving pre-collision information from an autonomous driving system, (ii) receiving an acceleration signal from an acceleration sensor, and (iii) determining whether to deploy the airbag based on the pre-collision information and the acceleration signal. The ignition threshold of the airbag is dynamically adjusted according to the pre-collision information. An associated airbag control device, a computer program product, and an airbag control system are also disclosed.

This application claims priority under 35 U.S.C. § 119 to application no. CN 2024 1072 2040.0, filed on Jun. 5, 2024 in China, the disclosure of which is incorporated herein by reference in its entirety.

The present application relates to the field of airbag control, and more specifically, to an airbag control method and device, a computer program product, and an airbag control system.

### BACKGROUND

The electronic control unit (ECU) of an airbag (hereinafter referred to as AB ECU), as a crucial module of the automotive passive safety system, is used to detect collision acceleration signals and control the ignition timing of the airbag, playing an important role in protecting the personal safety of occupants.

Existing AB ECUs determine when to ignite and deploy the safety device (i.e., the airbag) solely based on acceleration signals. However, in certain extreme scenarios where the acceleration signal is relatively small (for example, in a collision where the impact area is limited to the front center pillar, resulting in significant deformation of the vehicle's central structure and energy absorption, thus causing only a minor change in vehicle velocity and ultimately a small acceleration signal), the AB ECU may not be able to promptly detect the collision. This may result in the airbag not being triggered quickly or even not being triggered at all, thereby failing to provide optimal protection to the occupants.

### SUMMARY

According to one aspect of the present application, an airbag control method is provided, the method comprising: receiving pre-collision information from an autonomous driving system; receiving an acceleration signal from an acceleration sensor; and determining whether to deploy the airbag based on the pre-collision information and the acceleration signal, wherein the ignition threshold of the airbag is dynamically adjusted according to the pre-collision information.

As a supplement or alternative to the above solution, in the method described above, the pre-collision information includes pre-collision time to impact (TTI), relative velocity, and target type.

As a supplement or alternative to the above solution, in the method described above, determining whether to deploy the airbag based on the pre-collision information and the acceleration signal comprises: performing signal activation verification on the pre-collision information; performing a first acceleration threshold verification on the acceleration signal; if both the signal activation verification and the first acceleration threshold verification are passed, performing TTI acceptability verification on the pre-collision information; after passing the TTI acceptability verification, adjusting the ignition threshold based on the relative velocity in the pre-collision information; and deploying the airbag if the acceleration signal exceeds the adjusted ignition threshold.

As a supplement or alternative to the above solution, in the method described above, after passing the TTI acceptability verification, the greater the relative velocity, the lower the adjusted ignition threshold; and if the TTI acceptability verification is not passed, the ignition threshold remains at its original value.

As a supplement or alternative to the above solution, in the method described above, performing signal activation verification on the pre-collision information comprises: verifying whether the target type is a tree or utility pole; verifying whether the TTI is less than or equal to a first threshold (e.g., 500 ms); and verifying whether the relative velocity is greater than or equal to a second threshold (e.g., 30 km/h).

As a supplement or alternative to the above solution, in the method described above, if both the signal activation verification and the first acceleration threshold verification are passed, performing TTI acceptability verification on the pre-collision information comprises: performing a blind spot verification on the pre-collision information to determine an updated TTI; calculating a TTI interpolation based on the updated TTI; and verifying whether the TTI interpolation falls within an acceptance time window.

As a supplement or alternative to the above solution, in the method described above, performing blind spot verification on the pre-collision information comprises: calculating the actual distance, wherein the actual distance equals the product of the TTI and the relative velocity in the pre-collision information; and if the actual distance is less than a blind spot length threshold, discarding the newly input pre-collision time TTI and using the last valid signal frame before entering the blind spot as the updated TTI; otherwise, the updated TTI equals the pre-collision time TTI in the pre-collision information.

As a supplement or alternative to the above solution, in the method described above, calculating TTI interpolation based on the updated pre-collision time TTI comprises: if the updated TTI is the same as the previous frame's TTI value, the TTI interpolation being calculated as:

$$TTIinterpolation = TTIp - {t}_{cycle} ,$$

where TTIᵢₙₜₑᵣₚₒₗₐₜᵢₒₙ denotes the TTI interpolation, TTIp is the previous frame's TTI value, and t_{cycle} denotes the deployment calculation cycle of the airbag control system.

According to another aspect of the present application, an airbag control device is provided, the device comprising: a first receiving mechanism, configured to receive pre-collision information from an autonomous driving system; a second receiving mechanism, configured to receive acceleration signals from an acceleration sensor; and a determination mechanism, configured to determine whether to deploy the airbag based on the pre-collision information and the acceleration signal, wherein the ignition threshold of the airbag is dynamically adjusted according to the pre-collision information.

As a supplement or alternative to the above solution, in the device described above, the pre-collision information includes pre-collision time TTI, relative velocity, and target type.

As a supplement or alternative to the above solution, in the device described above, the determination mechanism comprises: a signal activation verification unit, configured to perform signal activation verification on the pre-collision information; a first acceleration threshold verification unit, configured to perform a first acceleration threshold verification on the acceleration signal; a TTI acceptability verification unit, configured to perform TTI acceptability verification on the pre-collision information if both the signal activation verification unit and the first acceleration threshold verification unit pass verification; an adjustment unit, configured to adjust the ignition threshold based on the relative velocity in the pre-collision information after passing the TTI acceptability verification; and a control unit, configured to send a control signal to deploy the airbag if the acceleration signal exceeds the adjusted ignition threshold.

As a supplement or alternative to the above solution, in the device described above, the signal activation verification unit is configured to: verify whether the target type is a tree or utility pole; verifying whether the TTI is less than or equal to a first threshold; and verify whether the relative velocity is greater than or equal to a second threshold.

As a supplement or alternative to the above solution, in the device described above, the TTI acceptability verification unit is configured to: perform a blind spot verification on the pre-collision information to determine an updated TTI; calculate a TTI interpolation based on the updated TTI; and verify whether the TTI interpolation falls within an acceptance time window.

According to another aspect of the present application, a computer program product is provided, which comprises a computer program, and the computer program, when executed by the processor, implements the method as described above.

According to yet another aspect of the present application, an airbag control system is provided, the system comprising: an airbag control device as described above; an acceleration sensor; and an airbag, wherein the airbag control device is configured to determine whether to deploy the airbag based on the acceleration signal provided by the acceleration sensor and the pre-collision information provided by the autonomous driving system via the in-vehicle network.

In addition to the acceleration signal, the airbag control scheme according to embodiments of the present application further introduces environmental signals (i.e., pre-collision information) received from the autonomous driving system (for example, an ADAS system), and determines whether to deploy the airbag based on both the pre-collision information and the acceleration signal. In this way, by utilizing the pre-collision information provided by the autonomous driving system, the airbag control scheme according to embodiments of the present application can quickly and accurately detect extreme scenarios (such as frontal center pillar collisions, rear-end collisions with trucks, etc.) in advance, thereby optimizing the protective performance of the airbag control system and reducing the safety risk to vehicle occupants in extreme situations. Additionally, in one or more embodiments, the airbag ignition threshold is dynamically adjusted based on the pre-collision information, which can further enhance the protective performance of the airbag control system.

### BRIEF DESCRIPTION OF THE DRAWINGS

The foregoing and other objectives and advantages of the present application will become more fully apparent from the following detailed description taken in conjunction with the accompanying drawings, in which identical or similar elements are denoted by the same reference numerals.

FIG. 1 illustrates a flow diagram of an airbag control method according to one embodiment of the present application;

FIG. 2 illustrates a structural diagram of an airbag control device according to one embodiment of the present application;

FIG. 3 illustrates a flow diagram of an airbag control method according to one embodiment of the present application;

FIG. 4 illustrates a schematic diagram of blind spot length according to one embodiment of the present application; and

FIG. 5 illustrates a schematic diagram of the interaction between the airbag control system and the autonomous driving system according to one embodiment of the present application.

### DETAILED DESCRIPTION

In the following, control schemes for the airbag according to various exemplary embodiments of the present application will be described in detail with reference to the accompanying drawings.

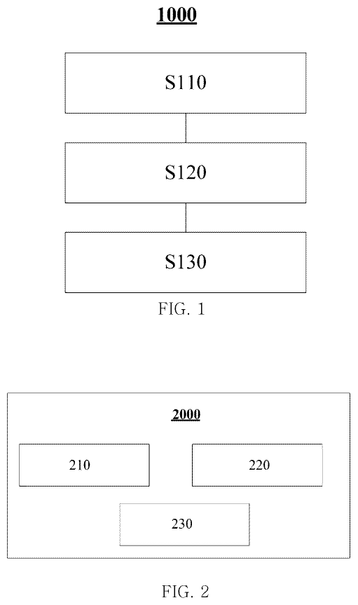

FIG. 1 illustrates a flow diagram of an airbag control method 1000 according to one embodiment of the present application. As shown in FIG. 1, the airbag control method 1000 comprises the following steps:
In step S110, pre-collision information is received from the autonomous driving system;
In step S120, acceleration signals are received from the acceleration sensor; and
In step S130, it is determined whether to deploy the airbag based on the pre-collision information and the acceleration signals, wherein the ignition threshold of the airbag is dynamically adjusted according to the pre-collision information.

In the context of the present application, the term “autonomous driving system” refers to a system that relies on the synergy of artificial intelligence, computer vision, radar, and other technologies to assist the driver or to operate the vehicle automatically and safely in the absence of human intervention. In one embodiment, the autonomous driving system is an ADAS (Advanced Driver Assistance System). It utilizes a variety of sensors installed on the vehicle (e.g., millimeter-wave radar, lidar, monocular/binocular cameras, satellite navigation, etc.) to sense the surrounding environment in real time during vehicle operation, collect data, identify, detect, and track static and dynamic objects, and, in combination with navigation map data, perform system computation and analysis. This enables the driver to be alerted to potential hazards in advance, thereby effectively enhancing driving comfort and safety. In one embodiment, the advanced driver assistance system may include functions such as lane keeping, navigation and real-time traffic system (TMC), intelligent speed adaptation/advice (ISA), vehicular communication systems, adaptive cruise control (ACC), lane departure warning system (LDWS), collision avoidance or pre-crash system, night vision system, adaptive light control, pedestrian protection system, automatic parking, traffic sign recognition, blind spot detection, driver drowsiness detection, hill descent control, and electric vehicle warning sounds, among others.

The term “pre-collision information” refers to collision warning/prediction information related to the host vehicle, which may be obtained, for example, by fusing forward environmental information acquired by the autonomous driving system's cameras, radar, and other sensors.

In one embodiment, the pre-collision information includes pre-collision time to impact (TTI), relative velocity, and target type. The “target type” refers to the type or classification of the obstacle (i.e., target) in front of the host vehicle, including but not limited to pedestrians, utility poles, trees, trucks, etc. “Relative velocity” (also referred to as “approach velocity”) denotes the relative speed between the host vehicle and the obstacle (i.e., target) ahead. When the target type is a static object such as a utility pole or tree, the “relative velocity” is equal to the absolute speed of the host vehicle. “Pre-collision time to impact (TTI)” refers to the predicted time required for the host vehicle to continue moving until a collision occurs.

In step S130, it is determined whether to deploy the airbag based on the pre-collision information and the acceleration signals, wherein the ignition threshold of the airbag is dynamically adjusted according to the pre-collision information. In one example, step S130 comprises: performing signal activation verification on the pre-collision information; performing a first acceleration threshold verification on the acceleration signal; if both the signal activation verification and the first acceleration threshold verification are passed, performing TTI acceptability verification on the pre-collision information; after passing the TTI acceptability verification, adjusting the ignition threshold based on the relative velocity in the pre-collision information; and deploying the airbag if the acceleration signal exceeds the adjusted ignition threshold.

In the above embodiment, before using the pre-collision information, “signal activation verification” is performed on the pre-collision information to determine whether the currently received pre-collision information from the autonomous driving system is valid. In one embodiment, “signal activation verification” may include: verifying whether the target type contained in the pre-collision information is a tree or utility pole; verifying whether the TTI contained in the pre-collision information is less than or equal to a first threshold (e.g., 500 ms); and verifying whether the relative velocity contained in the pre-collision information is greater than or equal to a second threshold (e.g., 30 km/h). If all these verification results are “yes”, the “signal activation verification” is passed; otherwise, the verification fails.

As mentioned above, one of the conditions for passing the “signal activation verification” is that the pre-collision time TTI should be less than or equal to the first threshold, for example, less than 500 ms. This is because when the pre-collision time TTI is greater than 500 ms, i.e., when there is still a certain distance between the host vehicle and the obstacle ahead, there is no need to activate the subsequent airbag control function. In addition, another condition for passing the “signal activation verification” is that the relative velocity should be greater than or equal to the second threshold, for example, greater than 30 km/h. This mainly considers that the severity of a collision and the potential injury to passengers are limited when the relative velocity is below 30 km/h.

In one embodiment, the pre-collision information further includes the AEB (Autonomous Emergency Braking) status, which only affects the signal activation verification. Specifically, when the AEB status is in the triggered state and other signal activation verification conditions are met, the “signal activation verification” is passed; otherwise, the verification fails. It should be noted that the AEB status signal is optional, i.e., it may or may not be included in the pre-collision information.

In addition to performing signal activation verification on the pre-collision information, a “first acceleration threshold verification” is also performed on the acceleration signal to exclude the vast majority of erroneous operations (e.g., due to rough road surfaces). For example, the “first acceleration threshold verification” includes determining whether the acceleration signal received from the acceleration sensor exceeds a preset threshold (e.g., 3g). If exceeded, the “first acceleration threshold verification” is passed; otherwise, the verification fails, and the next pre-collision information and acceleration signal are checked.

If both the “signal activation verification” and the “first acceleration threshold verification” are passed, a TTI acceptability verification is performed on the pre-collision information. The “TTI acceptability verification” is mainly used to determine whether the pre-collision time TTI contained in the pre-collision information falls within an allowable time window. If so, the “relative velocity” in the pre-collision information will be used for the triggering decision of the safety device (i.e., whether to deploy the airbag).

Existing safety device triggering decisions are based solely on the intensity of the acceleration signal. That is, when the intensity of the acceleration signal exceeds a preset threshold, the safety device is deployed. However, in one or more embodiments of the present application, relative velocity is further introduced into the deployment decision process. In one embodiment, different ignition thresholds (i.e., acceleration thresholds for meeting airbag deployment conditions) may be dynamically adopted according to the magnitude of the relative velocity.

Since relative velocity can reflect the severity of a (potential) collision, in one embodiment, after passing the “TTI acceptability verification,” the greater the relative velocity, the lower the adjusted ignition threshold (i.e., the easier it is to deploy the airbag); whereas if the “TTI acceptability verification” is not passed, the ignition threshold remains at the original threshold.

In one embodiment, if the relative velocity falls within the range of [0, 30 km/h], the original ignition threshold is used to determine whether to deploy the airbag. If the relative velocity is within the range of [30 km/h, v1], a second ignition threshold is used; if the relative velocity is within the range of [v1, v2], a third ignition threshold is used; and if the relative velocity is within the range of [v2, v3], a fourth ignition threshold is used, where v1<v2<v3, and the original ignition threshold>first ignition threshold>second ignition threshold>third ignition threshold.

It should be noted that the ignition threshold (original threshold) of existing airbag control systems is calibrated by the airbag control system itself. Unlike the prior art, one or more embodiments of the present application influence the airbag control system by introducing relative velocity (when necessary), thereby enabling earlier deployment of the airbag.

It should be further noted that for the three verifications, namely “signal activation verification,” “first acceleration threshold verification,” and “TTI acceptability verification,” recalculation is performed in each deployment calculation cycle, and there will not be a situation where, after passing verification in the current cycle, verification is skipped in the next cycle. In other words, in each deployment calculation cycle (hereinafter referred to as the calculation cycle or deployment cycle), these three verifications are checked to see if the requirements are met, and if so, the ignition threshold is adjusted.

In one embodiment, performing TTI acceptability verification on pre-collision information includes: performing a blind spot verification on the pre-collision information to determine an updated TTI; calculate a TTI interpolation based on the updated TTI; and verify whether the TTI interpolation falls within an acceptance time window.

Considering that there are blind spots in the camera's field of view, and the recognition accuracy of the camera decreases within these blind spots. Therefore, when the target falls into the camera's blind spot, the corresponding pre-collision time should be discarded. In one embodiment, performing blind spot verification on the pre-collision information includes: calculating the actual distance, wherein the actual distance equals the product of the TTI and the relative velocity in the pre-collision information; and if the actual distance is less than a blind spot length threshold, discarding the newly input pre-collision time TTI and using the last valid signal frame (where “valid” refers to a signal that has passed the “signal activation verification”) before entering the blind spot as the updated TTI; otherwise, the updated TTI equals the pre-collision time TTI in the pre-collision information. That is, the blind spot determination formula is: TTI×approach velocity<blind spot length threshold.

Referring to FIG. 4, it illustrates a schematic diagram of the blind spot length according to one embodiment of the present application. As shown in FIG. 4, for vehicle 410, 430 indicates the installation position of the camera, and 420 indicates the blind spot length 420. It can be seen that the blind spot length 420 depends on the camera installation position 430 and the front structure of vehicle 410. In one embodiment, the blind spot length threshold is set as a piecewise function, that is, when the blind spot length of the vehicle is less than or equal to 2 meters, the blind spot length threshold is set equal to the blind spot length; when the blind spot length of the vehicle is greater than 2 meters, the blind spot length threshold is set to 2 meters. In this way, the blind spot determination scheme of the present application can achieve a good balance between stability and accuracy.

Considering that the deployment (algorithm) calculation cycle of the airbag control system may be much shorter than the transmission cycle of the vehicle bus, the AB ECU is likely to obtain the same TTI value over several calculation cycles. Therefore, in addition to entering the blind spot, when the currently received TTI is the same as the previous frame's TTI value, the TTI should not be updated, but rather a countdown should be performed based on the previous frame's TTI value, i.e., TTI interpolation is calculated according to the following formula:

$$TTIinterpolation = TTIp - {t}_{cycle} ,$$

where TTIᵢₙₜₑᵣₚₒₗₐₜᵢₒₙ denotes the TTI interpolation, TTIp is the previous frame's TTI value, and t_{cycle} denotes the deployment (algorithm) calculation cycle of the airbag control system.

After calculating the TTI interpolation, it is further necessary to verify whether the TTI interpolation falls within the acceptable time window. In one embodiment, the acceptable time window comprises two parts−TTI transmission delay

TTIdelay and maximum TTI deviation TTIDeviation. In this embodiment, the acceptable time window for TTI is [−TTIdelay−TTIDeviation, TTIdelay+TTIDeviation].

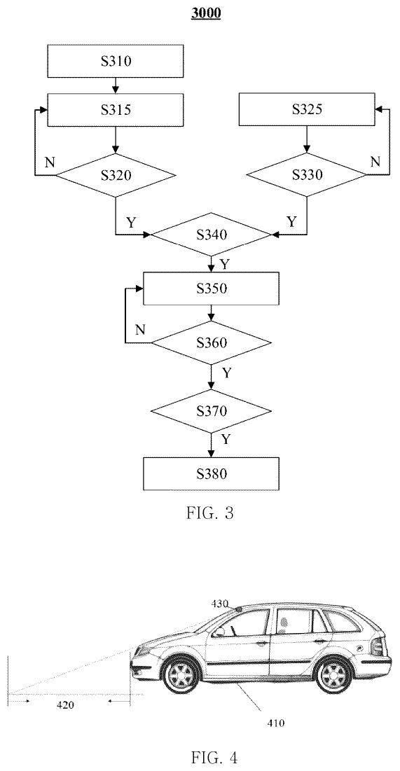

FIG. 3 illustrates a flow diagram of an airbag control method 3000 according to one embodiment of the present application. As shown in FIG. 3, in step S310, pre-collision information is received from the ADAS system (including pre-collision time TTI, relative velocity, and target type); in step S315, “signal activation verification” is performed on the pre-collision information, and subsequently in step S320, it is determined whether the “signal activation verification” is passed. If passed, step S340 is executed; otherwise, the process returns to step S315. In step S325, an acceleration signal is received from the acceleration sensor; subsequently, in step S330, “first acceleration threshold verification” is performed, i.e., it is determined whether the received acceleration signal exceeds a preset threshold; if so, the “first acceleration threshold verification” is passed, and step S340 is executed; otherwise, the process returns to step S325. In step S340, it is determined whether both the “signal activation verification” and the “first acceleration threshold verification” have been passed; if so, step S350 is executed. In step S350, a “TTI acceptability verification” is performed on the pre-collision information; in step S360, it is determined whether the “TTI acceptability verification” has been passed; if so, step S380 is executed to dynamically adjust the airbag ignition threshold based on the relative velocity.

Additionally, it will be readily understood by those skilled in the art that one or more embodiments of the airbag control method 1000 or 3000 provided in the present application may be implemented by way of a computer program. For example, the computer program is contained in a computer program product, and, when executed by a processor, implements one or more embodiments of the airbag control method 1000 or 3000 of the present application. As another example, when a computer-readable storage medium (e.g., a USB drive) storing the computer program is connected to a computer, execution of the computer program enables the implementation of one or more embodiments of the airbag control method 1000 or 3000 of the present application.

Referring to FIG. 2, it illustrates a schematic structural diagram of an airbag control device 2000 according to an embodiment of the present application. As shown in FIG. 2, the control device 2000 comprises: a first receiving mechanism 210, a second receiving mechanism 220, and a determination mechanism 230. Wherein, the first receiving mechanism 210 is configured to receive pre-collision information from an autonomous driving system; the second receiving mechanism 220 is configured to receive acceleration signals from an acceleration sensor; and the determination mechanism 230 is configured to determine whether to deploy the airbag based on the pre-collision information and the acceleration signal, wherein the ignition threshold of the airbag is dynamically adjusted according to the pre-collision information.

The term “pre-collision information” refers to collision warning/prediction information related to the host vehicle, which may be obtained, for example, by fusing forward environmental information acquired by the autonomous driving system's cameras, radar, and other sensors.

In one embodiment, the pre-collision information includes pre-collision time to impact (TTI), relative velocity, and target type. The “target type” refers to the type or classification of the obstacle (i.e., target) in front of the host vehicle, including but not limited to pedestrians, utility poles, trees, trucks, etc. “Relative velocity” (also referred to as “approach velocity”) denotes the relative speed between the host vehicle and the obstacle (i.e., target) ahead. When the target type is a static object such as a utility pole or tree, the “relative velocity” is equal to the absolute speed of the host vehicle. “Pre-collision time to impact (TTI)” refers to the predicted time required for the host vehicle to continue moving until a collision occurs.

The determination mechanism 230 is configured to determine whether to deploy the airbag based on the pre-collision information, wherein the ignition threshold of the airbag is dynamically adjusted according to the pre-collision information. In one embodiment, although not shown in FIG. 2, the determination mechanism 230 comprises: a signal activation verification unit, configured to perform signal activation verification on the pre-collision information; a first acceleration threshold verification unit, configured to perform a first acceleration threshold verification on the acceleration signal; a TTI acceptability verification unit, configured to perform TTI acceptability verification on the pre-collision information if both the signal activation verification unit and the first acceleration threshold verification unit pass verification; an adjustment unit, configured to adjust the ignition threshold based on the relative velocity in the pre-collision information after passing the TTI acceptability verification; and a control unit, configured to send a control signal to deploy the airbag if the acceleration signal exceeds the adjusted ignition threshold.

In the above embodiment, before using the pre-collision information to determine whether to deploy the airbag, the signal activation verification unit is used to perform a “signal activation verification” on the pre-collision information to determine whether the pre-collision information currently received from the autonomous driving system is valid. In one embodiment, the signal activation verification unit may be configured to: verify whether the target type contained in the pre-collision information is a tree or utility pole; verify whether the TTI contained in the pre-collision information is less than or equal to a first threshold (e.g., 500 ms); and verify whether the relative velocity contained in the pre-collision information is greater than or equal to a second threshold (e.g., 30 km/h). If all these verification results are “yes”, the “signal activation verification” is passed; otherwise, the verification fails.

As mentioned above, one of the conditions for passing the “signal activation verification” is that the pre-collision time TTI should be less than or equal to the first threshold, for example, less than 500 ms. This is because when the pre-collision time TTI is greater than 500 ms, i.e., when there is still a certain distance between the host vehicle and the obstacle ahead, there is no need to activate the subsequent airbag control function. In addition, another condition for passing the “signal activation verification” is that the relative velocity should be greater than or equal to the second threshold, for example, greater than 30 km/h. This mainly considers that the severity of a collision and the potential injury to passengers are limited when the relative velocity is below 30 km/h.

In addition to performing a signal activation verification on the pre-collision information, a first acceleration threshold verification unit is also used to perform a “first acceleration threshold verification” on the acceleration signal, so as to exclude the vast majority of erroneous operations (e.g., due to rough road surfaces). For example, the first acceleration threshold verification unit may be configured to determine whether the acceleration signal received from the acceleration sensor exceeds a preset threshold (e.g., 3g). If exceeded, the “first acceleration threshold verification” is passed; otherwise, the verification fails, and the next pre-collision information and acceleration signal are checked.

If both the “signal activation verification” and the “first acceleration threshold verification” are passed, the TTI acceptability verification unit is configured to perform a TTI acceptability verification on the pre-collision information. The “TTI acceptability verification” is mainly used to determine whether the pre-collision time TTI contained in the pre-collision information falls within an allowable time window. If so, the “relative velocity” in the pre-collision information will be used for the triggering decision of the safety device (i.e., whether to deploy the airbag).

Existing safety device triggering decisions are based solely on the intensity of the acceleration signal. That is, when the intensity of the acceleration signal exceeds a preset threshold, the safety device is deployed. However, in one or more embodiments of the present application, relative velocity is further introduced into the deployment decision process. In one embodiment, the adjustment unit may dynamically adopt different ignition thresholds (i.e., acceleration thresholds for meeting airbag deployment conditions) according to the magnitude of the relative velocity.

Since relative velocity can reflect the severity of a (potential) collision, in one embodiment, after passing the “TTI acceptability verification,” the greater the relative velocity, the lower the adjusted ignition threshold (i.e., the easier it is to deploy the airbag); whereas if the “TTI acceptability verification” is not passed, the ignition threshold remains at the original threshold.

In one embodiment, if the relative velocity falls within the range of [0, 30 km/h], the adjustment unit uses the original ignition threshold to determine whether to deploy the airbag. If the relative velocity is within the range of [30 km/h, v1], the adjustment unit uses the second ignition threshold is used; if the relative velocity is within the range of [v1, v2], the adjustment uses the third ignition threshold is used; and if the relative velocity is within the range of [v2, v3], the adjustment unit uses the fourth ignition threshold is used, where v1<v2<v3, and the original ignition threshold>first ignition threshold>second ignition threshold>third ignition threshold.

It should be noted that existing airbag control systems only have a single ignition threshold, which is calibrated by the airbag control system. Unlike the prior art, one or more embodiments of the present application influence the airbag control system by introducing relative velocity (when necessary), thereby enabling earlier deployment of the airbag.

In one embodiment, the TTI acceptability verification unit is configured to: perform a blind spot verification on the pre-collision information to determine an updated TTI; calculate a TTI interpolation based on the updated TTI; and verify whether the TTI interpolation falls within an acceptance time window. The TTI acceptability verification unit may be configured to perform the methods described in the foregoing specific embodiments of “TTI acceptability verification”, which will not be repeated here.

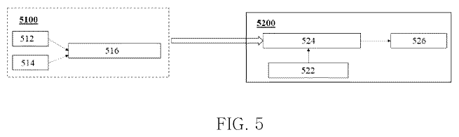

Referring to FIG. 5, it illustrates a schematic diagram of the interaction between the airbag control system 5200 and the autonomous driving system 5100 according to one embodiment of the present application. As shown in FIG. 5, the autonomous driving system 5100 acquires environmental signals in front of the vehicle via a camera 512 and a radar sensor 514. These environmental signals are processed by a fusion unit 516 to generate pre-collision information, which is then provided to the airbag control system 5200.

Furthermore, as depicted in FIG. 5, the airbag control system 5200 comprises: an airbag control device 524, an acceleration sensor 522, and an airbag 526. The airbag control device 524 is configured to determine whether to deploy the airbag 526 based on the acceleration signal provided by the acceleration sensor 522 and the pre-collision information provided by the autonomous driving system 5100 via the in-vehicle network (for example, a CAN bus).

In summary, the airbag control scheme according to embodiments of the present application further introduces environmental signals (i.e., pre-collision information) received from the autonomous driving system (for example, an ADAS system), and determines whether to deploy the airbag based on both the pre-collision information and the acceleration signal. In this way, by utilizing the pre-collision information provided by the autonomous driving system, the airbag control scheme according to embodiments of the present application can quickly and accurately detect extreme scenarios (such as frontal center pillar collisions, rear-end collisions with trucks, etc.) in advance, thereby optimizing the protective performance of the airbag control system and reducing the safety risk to vehicle occupants in extreme situations. Additionally, in one or more embodiments, the airbag ignition threshold is dynamically adjusted based on the pre-collision information, which can further enhance the protective performance of the airbag control system.

The above examples primarily illustrate the airbag control scheme of the embodiments of the present application. Although only certain embodiments of the present application have been described, those skilled in the art will understand that the present application may be embodied in many other forms without departing from its spirit and scope. Therefore, the examples and embodiments presented are illustrative rather than limiting, and the present application may encompass various modifications and replacements without departing from the spirit and scope defined by the various claims.

What is claimed is:

1. A control method for an airbag, comprising:
receiving pre-collision information from an autonomous driving system;
receiving an acceleration signal from an acceleration sensor; and
determining whether to deploy the airbag based on the pre-collision information and the acceleration signal, wherein an ignition threshold of the airbag is dynamically adjusted according to the pre-collision information.

2. The method according to claim 1, wherein the pre-collision information comprises pre-collision time to impact (TTI), relative velocity, and target type.

3. The method according to claim 2, wherein determining whether to deploy the airbag based on the pre-collision information and the acceleration signal comprises:
performing a signal activation verification on the pre-collision information;
performing a first acceleration threshold verification on the acceleration signal;
if both the signal activation verification and the first acceleration threshold verification are passed, performing a TTI acceptability verification on the pre-collision information;
after passing the TTI acceptability verification, adjusting the ignition threshold based on the relative velocity in the pre-collision information; and
deploying the airbag when the acceleration signal exceeds the adjusted ignition threshold.

4. The method according to claim 3, wherein after passing the TTI acceptability verification, the greater the relative velocity, the lower the adjusted ignition threshold; and if the TTI acceptability verification is not passed, the ignition threshold remains at its original value.

5. The method according to claim 3, wherein performing the signal activation verification on the pre-collision information comprises:
verifying whether the target type is a tree or utility pole;
verifying whether the pre-collision time to impact (TTI) is less than or equal to a first threshold; and
verifying whether the relative velocity is greater than or equal to a second threshold.

6. The method according to claim 3, wherein, if both the signal activation verification and the first acceleration threshold verification are passed, performing the TTI acceptability verification on the pre-collision information comprises:
performing a blind spot verification on the pre-collision information to determine an updated TTI;
calculating a TTI interpolation based on the updated TTI; and
verifying whether the TTI interpolation falls within an acceptance time window.

7. The method according to claim 6, wherein performing the blind spot verification on the pre-collision information comprises:
calculating an actual distance, wherein the actual distance equals the product of the TTI and the relative velocity in the pre-collision information; and
if the actual distance is less than a blind spot length threshold, discarding the newly input TTI and using the last valid signal frame before entering the blind spot as the updated TTI; otherwise, the updated TTI equals the TTI in the pre-collision information.

8. The method according to claim 6, wherein calculating the TTI interpolation based on the updated TTI comprises:
if the updated TTI is the same as the previous frame's TTI value, the TTI interpolation being calculated as:
$$TTIinterpolation = TTIp - tcycle ,$$
where TTIᵢₙₜₑᵣₚₒₗₐₜᵢₒₙ denotes the TTI interpolation, TTIp is the previous frame's TTI value, and t_{cycle} denotes the deployment calculation cycle of the airbag control system.

9. An airbag control device, comprising:
a first receiving mechanism configured to receive pre-collision information from an autonomous driving system;
a second receiving mechanism configured to receive an acceleration signal from an acceleration sensor; and
a determination mechanism configured to determine whether to deploy the airbag based on the pre-collision information and the acceleration signal, wherein the ignition threshold of the airbag is dynamically adjusted according to the pre-collision information.

10. The device according to claim 9, wherein the pre-collision information comprises pre-collision time to impact (TTI), relative velocity, and target type.

11. The device according to claim 10, wherein the determination mechanism comprises:
a signal activation verification unit configured to perform a signal activation verification on the pre-collision information;
a first acceleration threshold verification unit configured to perform a first acceleration threshold verification on the acceleration signal;
a TTI acceptability verification unit configured to perform a TTI acceptability verification on the pre-collision information if both the signal activation verification unit and the first acceleration threshold verification unit have passed;
an adjustment unit configured to adjust the ignition threshold based on the relative velocity in the pre-collision information after the TTI acceptability verification unit has passed; and
a control unit configured to send a control signal to deploy the airbag when the acceleration signal exceeds the adjusted ignition threshold.

12. The device according to claim 11, wherein the signal activation verification unit is configured to:
verify whether the target type is a tree or utility pole;
verify whether the pre-collision time to impact (TTI) is less than or equal to a first threshold; and
verify whether the relative velocity is greater than or equal to a second threshold.

13. The device according to claim 11, wherein the TTI acceptability verification unit is configured to:
perform a blind spot verification on the pre-collision information to determine an updated TTI;
calculate a TTI interpolation based on the updated TTI; and
verify whether the TTI interpolation falls within an acceptance time window.

14. A computer program product comprising a computer program, wherein, when executed by a processor, the computer program implements the method according to claim 1.

15. An airbag control system, comprising:
the device according to claim 9;
an acceleration sensor; and
an airbag,
wherein the device is configured to determine whether to deploy the airbag based on the acceleration signal provided by the acceleration sensor and the pre-collision information provided by the autonomous driving system via an in-vehicle network.
